(19) United States
(12) Patent Application Publication
(10) Pub. No.: US 2010/0277409 A1
(43) Pub. Date: Nov. 4, 2010

(54) TERMINAL, METHOD FOR CONTROLLING DISPLAY DEVICE THEREOF, AND RECORDING MEDIUM WHERE PROGRAM FOR CONTROLLING DISPLAY IS RECORDED

(76) Inventor: Kouji Yamamoto, Tokyo (JP)

Correspondence Address: Mr. Jackson Chen, 6535 N. STATE HWY 161, IRVING, TX, 75039, US

(21) Appl. No.: 12/738,873

(22) PCT Filed: Jan. 7, 2009
(86) PCT No.: PCT/JP2009/050400

§ 371 Date: Apr. 20, 2010

(30) Foreign Application Priority Data
Jan. 22, 2008 (JP) 2008-011117

(51) Int. Cl. G09G 3/36

(52) U.S. Cl. 345/102

(57) ABSTRACT

A terminal which a user can easily view a display by a display control is provided.

A terminal having a display capable of being controlled by a control signal, and a main terminal outputting a display signal to the display, characterized by including: a discriminant part for discriminating the usage state of the terminal; and a control part for controlling the frequency of the control signal to a predetermined first frequency when the usage state of the terminal discriminated by the discriminant part is judged as being in a specific usage state, and for controlling the frequency of the control signal to a second frequency which is lower than the first frequency when judged as being in a usage state other than the specific one.

### TECHNICAL FIELD

The present invention relates to a terminal equipped with a main terminal and a display, a method for controlling the display instrument thereof, and recording medium where program for controlling the display is recorded.

### BACKGROUND ART

In a display control of a display such as PC (personal computer) and a mobile communication terminal, various arts for making it much easier to view a display have been proposed. The followings are examples.

For example, in Japanese Patent Application Laid-Open No. 2006-267456 (patent document 1), a mobile communication terminal which controls luminance and coloration according to the viewer's angle of viewing a display is described. In addition, in Japanese Patent Application Laid-Open No. 2007-140436 (patent document 2), assuming that a user will play a game for a long period of time, the art of reducing fatigue of the user's eyes is disclosed. Furthermore, in Japanese Patent Application Laid-Open No. 2003-255913 (patent document 3). the art of controlling the luminance of a display screen for the light of a display device by controlling the duty ratio is disclosed. Moreover, in Japanese Patent Application Laid-Open No. 2007-241286 (patent document 4), the art of controlling the PWM (Pulse Width Modulation) frequency high for controlling a display in order to prevent flicker on a screen is disclosed.

Patent document 1; Japanese Patent Application Laid-Open No. 2006-267456

Patent document 2; Japanese Patent Application Laid-Open No. 2007-140436

Patent document 3; Japanese Patent Application Laid-Open No. 2003-255913

Patent document 4; Japanese Patent Application Laid-Open No. 2007-241286

### DISCLOSURE OF THE INVENTION

### Problems to be Solved by the Invention

The mobile communication device described in the above-mentioned patent document 1 controls the luminance low depending on the inclination of the mobile communication device when used. However, when viewing a TV sports program or using a game with intense movements, it is difficult to view when the luminance is controlled low.

In addition, the art disclosed in patent document 2, when in game mode, because the luminance is controlled slightly low, the effect of reducing the fatigue of the eyes can be expected. However, when playing a game with intensive movements, there is a possibility of being difficult to recognize and view movements with the low luminance. Especially when lowering the luminance by controlling the duty ratio, the off time per one cycle of the display becomes long, and depending on the angle of viewing, afterimage may be seen. For this reason, for games and the like with intense movements, there is a possibility of being particularly difficult to view.

Furthermore, the art disclosed in patent document 3 can reduce the horizontal stripes of a display screen by controlling the luminance of the display screen by controlling the duty ratio. However, in the art hereof, there is a possibility of being difficult to view, depending on the state of an angle and the like of a user towards the display screen and the usage state of the display apparatus equipped with a display screen. The art described in patent document 3 mentioned above is not for eliminating the difficulty of the user to view in the case hereof.

Moreover, the art described in patent document 4, it is the lighting of the backlight of a liquid crystal display instrument that the high PWM frequency controls, and with this control, flicker can be reduced. However, the art described in the above-mentioned patent document 4, it is not for preventing the afterimage occurring when displaying moving image with relatively intense movements. Furthermore, in this above-mentioned patent document 4, there are neither descriptions nor suggestions on how to make the display to be seen easily with controlling afterimage or when there is shaking on a screen when browsing the screen while carried around.

It is an object of the present invention to resolve the above-mentioned problems and to provide a terminal which a user can easily view the display by a display control, a method for controlling a display of the terminal, and recording medium where program for controlling the display is recorded.

### Technical Solutions

The present invention is for solving the above-mentioned problems and the terminal of the present invention, comprising equipped with a display capable of being controlled by a control signal and a main terminal outputting a display signal to the display, comprises a discriminant part for discriminating the usage state of the terminal and a control part for controlling the frequency of the control signal to a predetermined first frequency when the usage state of the terminal discriminated by the discriminant part is judged to be in a specific usage state, and for controlling the frequency of the control signal to a second frequency which is lower than the first frequency when the discriminated usage state is judged as being in a usage state other than the specific one.

In addition, a method for controlling a display of the terminal of the present invention, is for controlling the display of the terminal equipped with a display possible to have display capable of being controlled by a control signal and a main terminal outputting a display signal to the display, and comprises a state discriminant step for discriminating the usage state of the terminal and a judging step for judging the usage state of the terminal discriminated in the said state discriminant step to be whether in a specific usage state or not, and a control step for controlling the controlled frequency of the control signal of the display to predetermined first frequency when the usage state is judged to be in, a specific state, and to control the frequency of the control signal of the display to the second frequency which is lower than the first frequency when judged as being in other state than the specific state in the judging step.

Furthermore, a recording medium for controlling a display of the terminal of the present invention, is for controlling the display of the terminal equipped with a display possible to have display capable of being controlled by a control signal and a main terminal outputting a display signal to the display, and comprises a state discriminant function for discriminating the usage state of the terminal and a judging function for judging the usage state of the terminal discriminated in the said state discriminant function to be whether in a specific usage state or not, and a control function for controlling the controlled frequency of the control signal of the display to predetermined first frequency when the usage state is judged to be in a specific state, and to control the frequency of the control signal of the display to the second frequency which is lower than the first frequency when judged as being in other state than said specific state in the judging function.

### THE ADVANTAGEOUS EFFECT OF THE INVENTION

The present invention constructed as shown above proves advantageous effect as described in the following.

In the present invention, when the usage state of a terminal is in the specific usage state, the controlled frequency is controlled to the first frequency which is higher than the second frequency. As a result, according to the present invention, by controlling with a control signal of the higher frequency, afterimage of a display instrument can be controlled. For this reason, when a terminal is shaking while its user is in the move, or when the use is playing a game on the terminal with intense movements, it is possible to have a display easy to view for a user.

### BRIEF DESCRIPTION OF THE DRAWINGS

FIG. 1 is a schematic configuration diagram of a terminal according to a first exemplary embodiment of the present invention.

FIG. 2 is a flow chart showing an operation of the terminal according to the first exemplary embodiment of the present invention.

FIG. 3 is a schematic block diagram showing a terminal according to a second exemplary embodiment of the present invention.

FIG. 4 is an appearance diagram showing a terminal according to the second exemplary embodiment of the present invention.

FIG. 5 is a flow chart showing an operation of the terminal according to the second exemplary embodiment of the present invention.

FIG. 6 is a schematic block diagram showing a terminal according to a third exemplary embodiment of the present invention.

FIG. 7 is an appearance diagram showing the terminal according to the third exemplary embodiment of the present invention.

FIG. 8 is a flow chart showing an operation of the terminal according to the third exemplary embodiment of the present invention.

### DESCRIPTION OF THE CODES

101 terminal

102 display

103 main terminal

104 discriminant part

105 control part

301 terminal

302 display

303 main terminal

304 key operation unit

305 acceleration sensor

306 CPU

307 RAM

308 ROM

309 PWM control unit

401 receiver unit

402 transmission unit

601 terminal

602 CPU

701 mouse

702 line

### BEST MODE FOR CARRYING OUT THE INVENTION

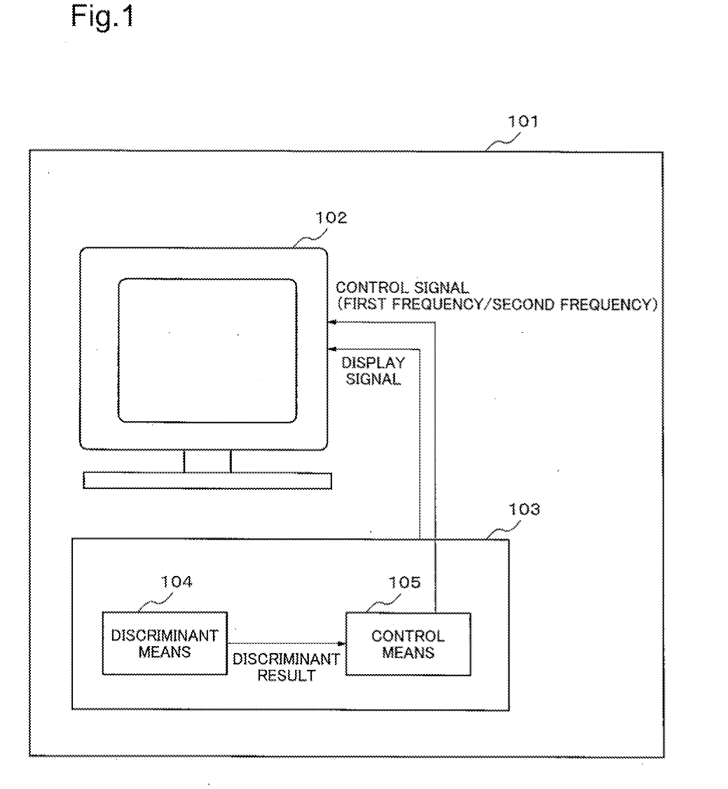

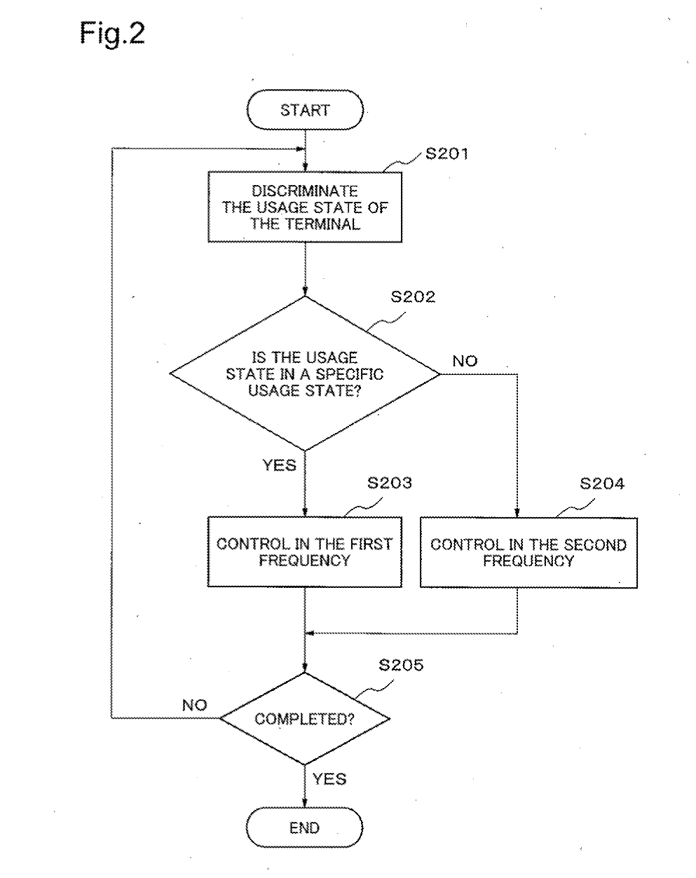

A first exemplary embodiment of the present invention is described based on FIG. 1 and FIG. 2.

FIG. 1 is a schematic configuration diagram of a terminal according to the first exemplary embodiment of the present invention. In addition, FIG. 2 is a flow chart showing an operation of the terminal according to the first exemplary embodiment of the present invention.

A terminal 101 includes a display 102 capable of being controlled by a control signal and a main terminal 103 outputting a display signal to the display 102. The main terminal 103 includes a discriminant part 104 to discriminate the usage state of the terminal 101, and a control part 105 for controlling the frequency of the control signal to the display instrument 102 depending on the usage state of the terminal 101 discriminated by the discriminant part 104.

The control part 105 controls the control signal to the display 102 to the predetermined first frequency when the usage state of the terminal 101 discriminated by the discriminant part 104, and controls the control signal to the second frequency which is lower than the aforementioned first frequency when the usage state is judged as being in a usage state other than the specific one. The second frequency is an optimum or almost an optimum controlled frequency for the terminal 101, set by the judgement of such as control property, calorific property, and electric power consumption property in a comprehensive manner.

The terminal 101 is judged to be in a specific usage state when the terminal is portable and its shaking is greater than the predetermined value while moving. In addition, when the terminal 101 operates under an application program of intense movements, or displays TV sports program with intense movements or action movies, these are exemplified as the specific usage state. The aforementioned discriminant part 104 discriminates whether the terminal 101 is in such state or not. Then, by receiving information on the discriminant result of the discriminant part 104, the control part 105 controls the control signal to the display. 102 to the first frequency or the second frequency.

In addition, as a concrete example of the terminal 101, there are PC (personal computer), mobile communication terminals (mobile phone, PHS (Personal Handy-phone System), PDA (Personal Digital Assistants, Personal Data Assistance), and game machine or the like.

The operation of the terminal 101 with the construction described above will be explained referring to the flow chart of FIG. 2.

In the terminal 101, the discriminant part 104 discriminates the usage state of the terminal 101 (step 201, hereinafter “step” is referred to as “S”). The control part. 105 receives the discriminant result from the discriminant part 104 and judges whether the usage state of the terminal 101 is in a specific state or not (whether in other states besides the specific one) (S202).

The control part 105 controls the display control signal to the first frequency (S203), when the usage state of the terminal 101 is judged as being in a specific state (YES in S202). In addition, the control part 105 controls the display control signal to the second frequency (S204) which is lower than the aforementioned first frequency, when the usage state of the terminal 101 is judged as being in a state other than the specific state (NO in S202). Furthermore, after the control part 105 controls the display control signal to the first frequency or to the second frequency, control part 105 discriminates whether the display control is completed or not (S205). By the discrimination of the S205, when it is discriminated as not completed (when NO in S205), the control will return to S201 again.

Since the terminal 101 operates as described above, the usage state of the terminal 101 is discriminated by the discriminant part 104. Then, for example, when the shaking of the terminal 101 is great due to the usage during moving, the control part 105 judges for being in a specific state and controls the control frequency to the first frequency. As a result, for example, even when a terminal 101 is shaking while its user is in the move, or when the user is playing a game on the terminal 101 with intense movements, it is possible to have an easily viewed display for a user.

The frequency control sets the aforementioned second frequency to a standard control frequency that is ordinarily used, and sets the above-mentioned first frequency to a frequency which is higher than the standard control frequency. As mentioned above, the standard control frequency (the second frequency) is set as an optimum or almost an optimum control frequency for the terminal 101, set by the judgement of such as control property, calorific property, and electrical power consumption property of electricity in a comprehensive manner. For this reason, it is undesirable to control the control frequency to the high frequency (the first frequency) on a steady basis or for a long period of time.

The frequency control, in view of the above description, for example it is controlled specifically to the high frequency (the first frequency) only when the shaking of the terminal 101 is greater than the predetermined value. As a result, by eliminating negative effects as much as possible when controlling to the high frequency (the first frequency), the control can be the one that is easy to view for a user.

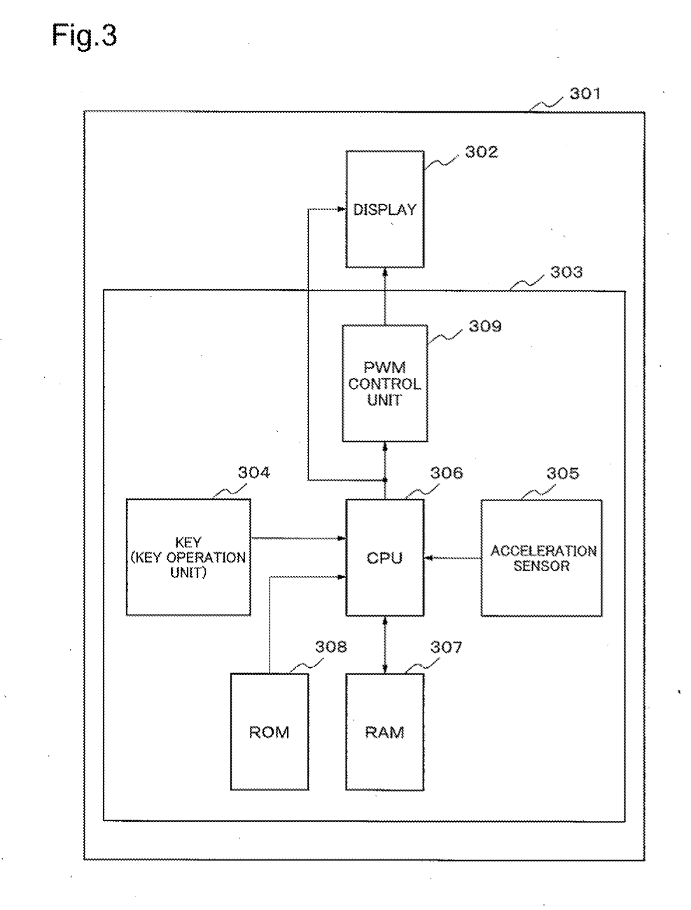

Next, a terminal according to a second exemplary embodiment will be described based on FIG. 3 to FIG. 5.

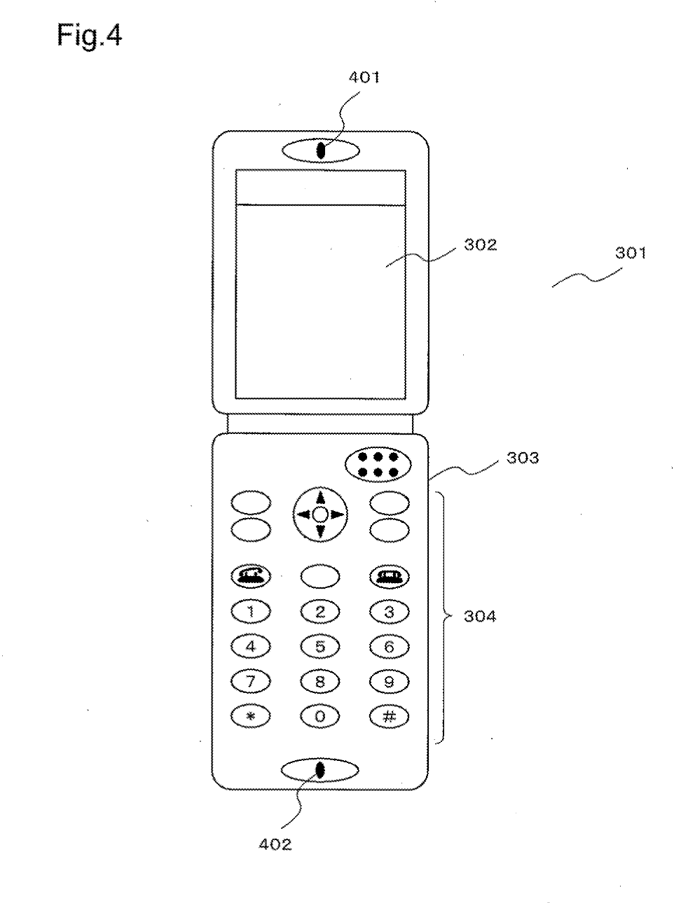

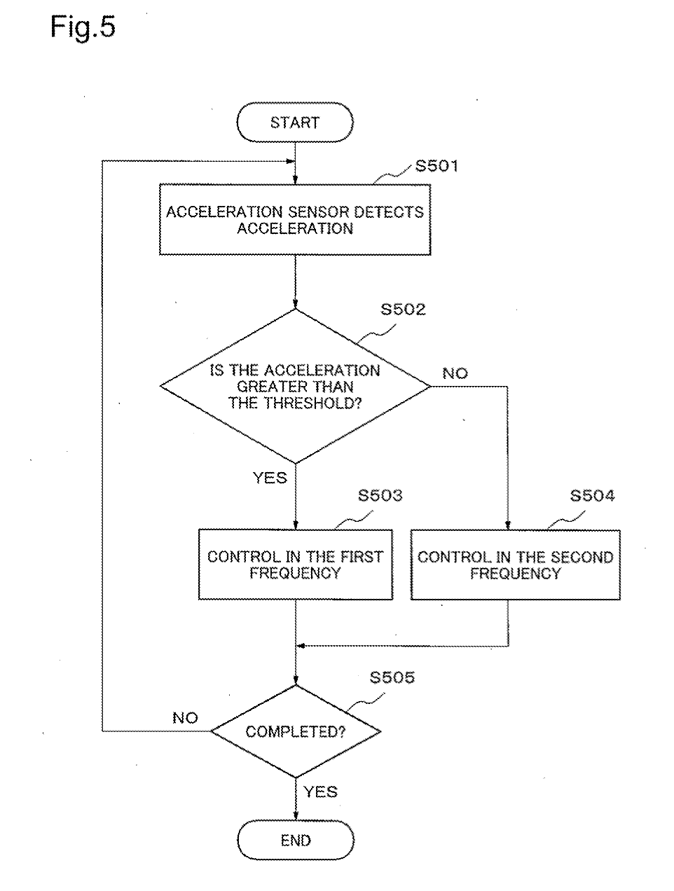

FIG. 3 is a schematic block diagram showing a terminal according to a second exemplary embodiment. FIG. 4 is an appearance diagram showing a terminal according to the second exemplary embodiment. FIG. 5 is a flow chart showing an operation of the terminal according to the second exemplary embodiment.

A terminal 301 shown in FIG. 3 is an example of a mobile communication terminal called as mobile phone. For this reason, though a diagram will be omitted, it includes radio-frequency transmission for accomplishing a radio-frequency transmission function, and a phone unit for accomplishing a phone function. The terminal 301 includes a display 302 capable of controlling the luminance by PWM control, and main terminal 303 outputting display signal or control signal to the display 302.

The main terminal 303 includes a key operation unit 304, an acceleration sensor 305, a CPU (Central Processing Unit) 306, a RAM (Random Access 211 Memory) 307, a ROM (Read Only Memory) 308, and a PWM control unit 309. The key operation unit 304 functions as an input device. The acceleration sensor 305 detects inclination or acceleration of the terminal 301. The CPU 306 performs an overall control of the terminal 301. The RAM 307 functions as readable/writeable storage device. The ROM 308 is a read-only storage device storing control program and the like. The PWM control unit 309 controls the luminance of the display 302 by PWM.

The PWM control unit 309 performs a control (duty ratio control) to control the width of onpulse for luminance control, and sets two ways of pulse control frequency (the first frequency and the second frequency which is lower than the first frequency) for the control thereof. Then, the PWM control unit 309 inputs the control signal from the CPU 306, and controls current of electricity for control of the display 302.

The acceleration sensor 305, as the discriminant part for discriminating the usage state of the terminal 301, detects the inclination or the acceleration and the like. Then, the acceleration sensor 305 detects the inclination or the acceleration of the terminal 301 and sends the detection result to the CPU 306.

The CPU 306 performs an input process or performs a program and the like of the terminal 301. Then, the CPU 306 inputs the detection result of the inclination or the acceleration of the terminal 301 from the acceleration sensor 305, and generates necessary information for display control at the PWM control unit 309. When the PWM control unit 309 outputs the generated control signal to the display 302, the display 302 is controlled. In addition, the CPU 306 collaborates with the RAM 307, the ROM 308 and the PWM control unit 309, and accomplish the function as control part for controlling the control signal.

A receiver unit 401 shown in FIG. 4 is one part of the transmission unit omitted in FIG. 3, and outputs voice received from other communication terminals during voice communication. The transmission unit 402 is one part of the transmission part omitted in FIG. 3, and it receives voice to be sent during a voice communication.

The key operation unit 304 described in FIG. 3, as shown in FIG. 4, is equipped with numeric keys, arrow keys, other keys and the like. Numeric keys are keys for inputting alphabetic characters and numerals (for character inputs). Arrow keys are keys for moving a cursor in left, right, top. and bottom, or performing decision operation. Other keys are for controlling other functions.

Since a terminal 301 shown in FIG. 4 is a mobile phone, it is carried around and used. For this reason, the angle of viewing a display 302 changes due to the shaking of the terminal 301 when it is carried in the train or when it is carried around by walking user and so on. For certain angle towards the display 302, the afterimage is highly visible, so that the display screen of the display 302 may be very difficult to view.

For this reason, by controlling the display control with the frequency of the PWM control, and by controlling the frequency to the first frequency, afterimage at the display is difficult to remain. The operation in the situation mentioned above will be described according to FIG. 5.

As it is shown in FIG. 5, when the display control is started, the acceleration sensor 305 detects the shakiness, in other words, the speed of acceleration of the terminal 301 (S501). The CPU 306 with inputted information on the detected acceleration, judges whether the acceleration is greater than the predetermined value (threshold) or not. When the CPU 306 judges the acceleration being greater than the predetermined value (YES in S502), it outputs a control signal to the PWM control unit 309 to have the control frequency in the first frequency. When the control signal is inputted from the CPU 306, the PWM control unit 309 sets the frequency of the control signal to the display 302 to the first frequency (S503).

When the CPU 306 judges the acceleration being not greater than the predetermined level at S502 (NO in S502), it outputs a control signal to the PWM control unit 309 to set the control frequency to the second frequency which is lower than the first frequency. When the control signal is inputted from the CPU 306, the PWM control unit 309 sets the frequency of the control signal to the display 302 to the second frequency (S504).

Then, after the PWM control unit 309 controls the display control signal to the first frequency or to the second frequency, the CPU 306 discriminates whether the display control is completed or not (S505). By the discrimination at S505, when it is discriminated as not being completed (in case of NO in S505), the control returns to S501 again.

For the terminal 301 is controlled as described above, when the shaking of the terminal 301 is great, the control frequency to the display 302 is controlled to the first frequency. When the control frequency is controlled to the first frequency which is higher, it is possible to have a display whose afterimage is difficult to see compared to the control at the second frequency. This is because by controlling with the high frequency, even when the ratio of the off time per one cycle is the same, the off time of the one cycle will be short. For this reason, the possibility of having afterimage by the angle viewed by a user can be prevented as much as possible. As a result, display can be easy to view for a user.

Furthermore, according to this exemplary embodiment, while the control frequency of the control signal has been changed, the duty ratio (on time per the unit time) of the control signal has not been changed. For this reason, the luminance of the display will not change either. As a result, a control such as increasing power consumption is not performed, and the disadvantage of increase in the power consumption is prevented.

The frequency control sets the aforementioned second frequency to a standard control frequency, and sets the aforementioned first frequency to a higher frequency than the standard frequency. For this reason, in the terminal 301, for example, when the terminal 301 is carried around and used, and only when the shakiness is greater than the predetermined level, it is specifically controlled to the high frequency. As described, only when the usage state of the terminal 301 is discriminated as being in a specific state, the control is performed at the first frequency which is higher than the second frequency which is equal to the aforementioned standard control frequency. By this display control, since the control frequency is controlled to the high frequency (the first frequency) only when necessary, the deterioration of radio-frequency property can be minimized compared to the control being always controlled in the high frequency (the first frequency). Furthermore, as same as the terminal 101 in the first exemplary embodiment, the terminal 301 in this second exemplary embodiment may also be controlled with the utmost deterioration reduction of the control property, calorific property, or electric power consumption property.

In addition, in this second exemplary embodiment, while the description is made using an example of the acceleration sensor 305, other sensors like, for example, vibration sensor may be used for detecting the shaking of the terminal 301.

Furthermore, as a concrete example of the terminal 301, besides the mobile phone shown in FIG. 4, PHS terminals, PDA, or game machines and the like is included.

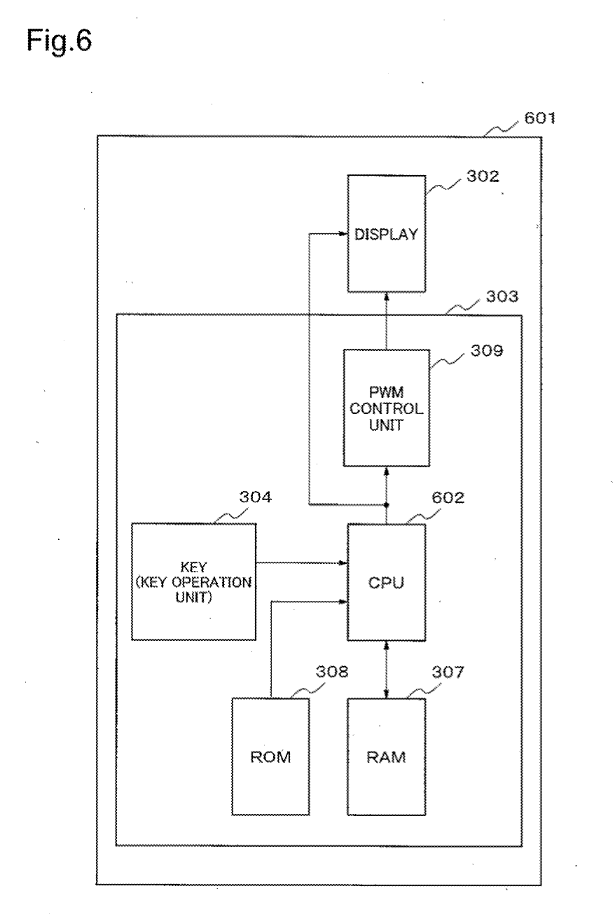

Next, a terminal according to the third exemplary embodiment will be described based on FIG. 6 to FIG. 8.

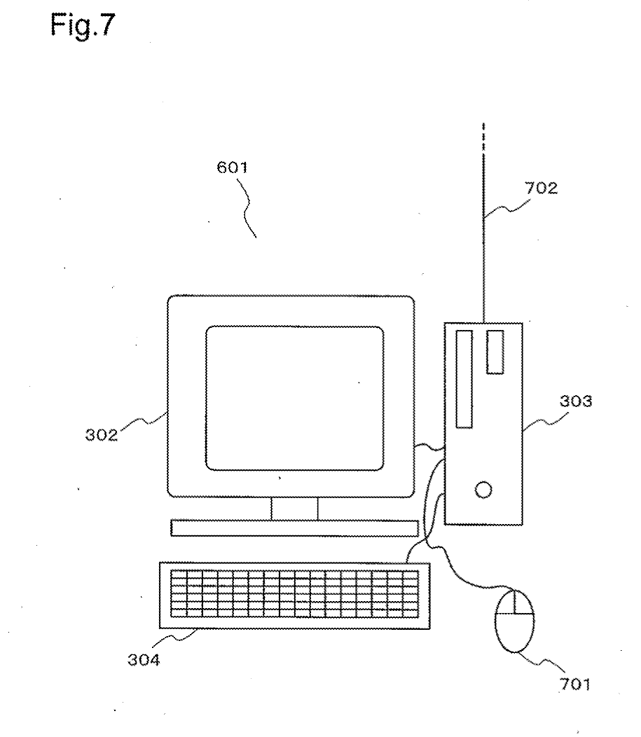

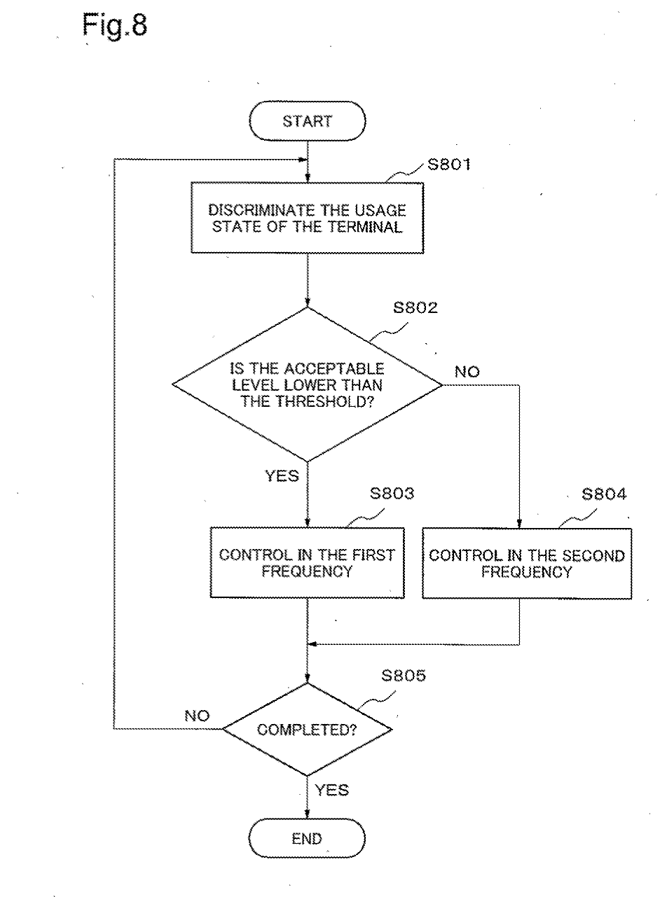

FIG. 6 is a schematic block diagram showing a terminal according to the third exemplary embodiment. FIG. 7 is an appearance diagram showing the terminal according to the third exemplary embodiment. FIG. 8 is a flow chart showing an operation of the terminal according to the third exemplary embodiment.

A terminal 601 shown in FIG. 6 is an example of a terminal called PC. The terminal 601 is different from the terminal 301 shown in FIG. 3 in that it does not include the acceleration sensor 305 of the terminal 301, and the control of a CPU 602 differs from the CPU 306 of the terminal 301. In addition, the same numerals are used for the same components of the terminal 301 shown in FIG. 3.

Because the CPU 602 is for performing an overall control of the terminal 601, it naturally comprehends which application program is used at the moment. Furthermore, the CPU 602 comprehends the contents of the application program being used, and whether the acceptable level of a deterioration of image quality is small or not (i.e. large).

In this exemplary embodiment, “the acceptable level of the deterioration of image quality is small” means that small used as if the deterioration of the image quality is acceptable. In other words, when the deterioration of the image quality is large in such a case as much afterimage is seen, a user cannot accept. On the contrary, when the deterioration of the image quality is small in such a case as afterimage is few, a user can accept.

For this reason, acceptable level for deterioration of image quality is low for games with intense movements due to intolerable disturbance for performing the game when the afterimage is large. Other examples of having low acceptable level of deterioration of image quality are TV sports program with intense movements, action movies and the like.

In contrast, the followings are the examples in which the acceptable level of the deterioration of image quality being large, in other words, even the deterioration of image quality is large it is still acceptable. For example, editing function of telephone book containing the address book, notepads, daily planners, TV (Television) programs with less intense movements (such as news programs and quiz shows), and games with less intense movements (such as puzzle games and card games). Here, display of TV programs and movie displays are all possible to be displayed by the application program installed in the terminal 601. For this reason, not only for games but also for display of TV programs and movie displays, the application program is used.

Then, when the CPU 602 judges that the application program of having small acceptable level of the deterioration of image quality is being used, the CPU 602 transmits a signal to the PWM control unit 309 and controls the control frequency of the transmitting signal to the display 302 to the first frequency. When other application programs are used besides that having small acceptable level of the deterioration of image quality, it can be assumed that the application program having a large acceptable level of the deterioration of image quality is used. When the CPU 602 judges the application program is used, it will transmit a signal to the PWM control unit 309 and controls the control frequency of the transmitting signal to the display 302 to the second frequency.

The terminal 601 shown in FIG. 7 includes a mouse 701 as an inputting device other than the key operation unit 304. Furthermore, the terminal 601 has a phone line and a line 702 such as LAN (Local Area Network) line, and can be connected to other networks.

The operation of the terminal 601 constructed as above will be described referring to FIG. 8.

As shown in FIG. 8, when a display control is started, the CPU 602 discriminates the usage state of the terminal 601 (S801). Then, the CPU 602 judges whether the acceptable level of the deterioration of image quality is less than the predetermined level (threshold), by discrimination of the usage state (S802).

When the acceptable level is small, in other words, when such as performing games with intense movements, the CPU 602 judges that the acceptable level is lower than the predetermined level (threshold) (YES in S802). Then, the CPU 602 outputs a control signal to the PWM control unit 309 to set the control frequency to the first frequency. When the control signal from the CPU 602 is inputted, the PWM control unit 309 sets the frequency of the control signal to the display 302 to the first frequency (S803).

In S802, when the CPU 602 judges the acceptable level of the deterioration of image quality is more than the predetermined level (threshold) (NO in S802), the CPU 602 outputs a control signal to the PWM control unit 309 to set the control frequency to the second frequency which is lower than the first frequency. When the control signal from the CPU 602 is inputted, the PWM control unit 309 sets the frequency of the control signal to the display 302 to the second frequency (S804).

Then, after the PWM control unit 309 controls the display control signal to the first frequency or to the second frequency, the CPU 602 discriminates whether the display control is completed or not (S805). When it is discriminated as being not completed by the discrimination of the S805, the control returns to the S801 again.

The terminal 601 being controlled as described above, when the CPU 602 judges the usage state of the terminal 601 is in a specific usage state, controls the control frequency to the display 302 to the first frequency. For this reason, display 302 can be easy to view for a user by controlling afterimage.

Furthermore, similar to the terminal in the first exemplary embodiment or in the second exemplary embodiment, this frequency control sets the aforementioned second frequency to the standard frequency, and sets the aforementioned first frequency to a frequency higher than the standard control signal. For this reason, in the terminal 601, for example, only when the acceptable level is lower than the predetermined level such as performing games with intense movements and the like, it is specifically controlled to a high frequency. As described, only when the usage state of the terminal 601 is judged as being in a specific usage state, it is controlled with the first frequency higher than the aforementioned standard control frequency (the second frequency). By this display control, since the display control is controlled with the first frequency having a high control frequency only when necessary, the terminal 601 in this third exemplary embodiment may also be controlled with the utmost deterioration reduction of the control property, calorific property, or electric power consumption property.

Moreover, the terminal 601 in this third exemplary embodiment does not include an acceleration sensor as in the terminal 301 in the second exemplary embodiment. Therefore, the construction can be simple, and its price can be moderate.

Above terminals of the first to the third exemplary embodiments, since the duty ratio of the display signal to a display have not been changed, the luminance has not been changed. However, when the control frequency gets high, the off time of the image display will be short, so such as when viewing a moving image with rapid movements or when the shaking of the terminal itself is relatively large, the afterimage seen at the off time can be negligible. For this reason, a display with reduced afterimage is possible, and a display can be easy to view for a user.

In addition, while detailed description will be omitted, by adding the control described in the third exemplary embodiment to the aforementioned second exemplary embodiment, display control may be performed in the terminal 301 in more cases.

In such a case, not only when the shaking is greater than the predetermined level, but also when the acceptable level of the deterioration of image quality of an application program is smaller than the predetermined level, the CPU 306 of the terminal 301 judges the state of the terminal 301 in the specific usage state, and sets the control frequency to the display 302 to the first frequency.

Furthermore, the first to the third exemplary embodiments are described as examples of controlling with the two control frequencies of the first frequency and the second frequency. However, three or more control frequencies may be adopted.

When three control frequencies are used, the state of the terminal should be able to be judged in three states.

For example, by using an acceleration sensor as a discriminant part, and when using three control frequencies (the first frequency, the second frequency, and the third frequency) to control, the state of the terminal should be discriminated in three states by setting two threshold levels (the predetermined values).

Moreover, when applying the art to control with three control frequencies by detecting the acceptable level of the deterioration of image quality of the application program, the state of the terminal should be possible to be discriminated in three states by setting two threshold levels (the predetermined values) of the acceptable level of the application program.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2008-011117, filed on Jan. 22, 2008, the disclosure of which is incorporated herein in its entirety by reference.

1-19. (canceled)

20. A terminal having a display capable of being controlled by a control signal, and a main terminal outputting a display signal to the display, comprising:
a discriminant part for discriminating the usage state of said terminal; and
a control part for controlling the frequency of said control signal to a predetermined first frequency when the usage state of the terminal discriminated by said discriminant part is judged as being in a specific usage state, and for controlling the frequency of said control signal to a second frequency which is lower than said first frequency when judged as being in a usage state other than said specific one.

21. The terminal according to claim 20, wherein said control signal is the control signal by a PWM control.

22. The terminal according to claim 20, wherein:
said discriminant part discriminates shaking of said terminal; and
said control part judges being in a specific usage state when the shaking discriminated by said discriminant part is greater than the predetermined value, and judges being in other state than said specific state when the shaking discriminated by said discriminant part is less than the predetermined value.

23. The terminal according to claim 20, wherein said discriminant part is an acceleration sensor.

24. The terminal according to claim 20, wherein:
said discriminant part discriminates an acceptable level of a deterioration of image quality of application program used in the terminal; and
said control part judges the usage state of the terminal being in a specific state when the acceptable level discriminated in said discriminant part is smaller than the predetermined value, and judges to be in other state than said specific usage state when the acceptable level discriminated by said discriminant part is greater than the predetermined value.

25. The terminal according to claim 20, wherein said terminal is a portable mobile communication terminal having a radio-frequency communication function.

26. A control method of a display in a terminal which includes a display capable of being controlled by control signal, and main terminal outputting the display signal to the display, comprising the steps of:
discriminating the usage state of said terminal;
judging whether or not the usage state of said terminal discriminated by said discriminating step is in a specific state; and
controlling the frequency of said control signal of said display to predetermined first frequency when the usage state is judged to be in a specific state, and for controlling the frequency of the control signal of said display to the second frequency which is lower than said first frequency when the usage state is judged to be being in other state than said specific state in said judging step.

27. The control method according to claim 26, wherein said control signal is a control signal by a PWM control.

28. The control method according to claim 26, wherein:
said discriminating step discriminates shaking of said terminal; and
said controlling step judges being in a specific usage state when the shaking discriminated by said discriminating step is greater than the predetermined value, and judges being in other state than said specific state when the shaking discriminated by said discriminating step is less than the predetermined value.

29. The control method according to claim 26, wherein said discriminant part used in said state discriminating step is an acceleration sensor.

30. The control method according to claim 26, wherein:
said discriminating step discriminates an acceptable level of a deterioration of image quality of application program used in the terminal; and
said controlling step judges the usage state of the terminal being in a specific state when the acceptable level discriminated in said discriminating step is smaller than the predetermined value, and judges to be in other state than said specific usage state when the acceptable level discriminated by said discriminating step is greater than the predetermined value.

31. The control method according to claim 26, wherein said terminal is a portable mobile communication terminal having radio-frequency communication function.

32. A recording medium to be accomplished by a computer, where a program for controlling a display is recorded, wherein a recording medium in a terminal, where a program for controlling a display is recorded, including a display possible to have a display control by a control signal and a main terminal outputting a display signal to the display:
a state discrimination function for discriminating the usage state of said terminal;
a judgement function for judging whether or not the usage state of said terminal discriminated by the state discrimination function is in a specific state; and
control function for controlling the frequency of said control signal of said display to predetermined first frequency when the usage state is judged to be in a specific state, and for controlling the frequency of the control signal of said display to the second frequency which is lower than said first frequency when the usage state is judged to be being in other state than said specific state in said judgement function.

33. The recording medium according to claim 32, wherein said control signal is a control signal by a PWM control.

34. The recording medium according to claim 32, wherein:
said discrimination function discriminates shaking of said terminal; and
said control function judges being in a specific usage state when the shaking discriminated by said discrimination function is greater than the predetermined value, and judges being in other state than said specific state when the shaking discriminated by said discrimination function is less than the predetermined value.

35. The recording medium according to claim 32, wherein said discrimination function used in said state discrimination function is an acceleration sensor.

36. The recording medium according to claim 32, wherein:
said discrimination function discriminates an acceptable level of a deterioration of image quality of application program used in the terminal; and
said control function judges the usage state of the terminal being in a specific state when the acceptable level discriminated in said discrimination function is smaller than the predetermined value, and judges to be in other state than said specific usage state when the acceptable level discriminated by said discrimination function is greater than the predetermined value.

37. The recording medium according to claim 32, wherein said terminal is a portable mobile communication terminal having radio-frequency communication function.
